(19) United States
(12) Patent Application Publication
(10) Pub. No.: US 2020/0090268 A1
(43) Pub. Date: Mar. 19, 2020

(54) METHOD AND APPARATUS FOR DETERMINING LEVEL OF RISK OF USER, AND COMPUTER DEVICE

(71) Applicant: ALIBABA GROUP HOLDING LIMITED, Grand Cayman (KY)

(72) Inventors: Fan YANG, HANGZHOU (CN); Xin FU, HANGZHOU (CN)

(21) Appl. No.: 16/690,949

(22) Filed: Nov. 21, 2019

Related U.S. Application Data
(63) Continuation of application No. PCT/CN2018/088192, filed on May 24, 2018.

(30) Foreign Application Priority Data
May 26, 2017 (CN) 201710385586.1

(51) Int. Cl. G06Q 40/02; G06Q 30/02

(52) U.S. Cl. CPC G06Q 40/025; G06Q 30/0201

(57) ABSTRACT

A method and an apparatus for determining a risk level of a user, and a computer device are provided, to improve the accuracy of a user risk level. The method for determining a risk level of a user includes: obtaining first user data and second user data of a user, the first user data reflecting at least one user attribute related to a risk tolerance of the user, and the second user data being behavior data generated during a risk-related transaction of the user; determining, according to the first user data, a first index for representing the risk tolerance of the user; determining, according to the second user data, a second index for representing a risk preference degree of the user; and determining a user risk level of the user according to the first index and the second index.

### CROSS REFERENCE TO RELATED APPLICATIONS

The present application is a continuation application of the International Patent Application No. PCT/CN2018/088192, filed on May 24, 2018, and titled “METHOD AND APPARATUS FOR DETERMINING LEVEL OF RISK OF USER, AND COMPUTER DEVICE,” which claims priority to Chinese Patent Application No. 201710385586.1 filed on May 26, 2017. The entire contents of all of the above applications are incorporated herein by reference in their entirety.

### TECHNICAL FIELD

This application relates to the field of big data technologies, and in particular, to a method and an apparatus for determining a risk level of a user.

### BACKGROUND

With the development of the Internet, many transactions can be implemented through Internet platforms. During the execution of some transactions, a platform needs to evaluate risk levels of users, and support the execution of the transactions by using the evaluated risk levels of the users. For example, in an Internet investment and financing scenario, financial products recommended by the platform to the users should conform to the risk levels of the users.

Currently, Internet platforms generally require users to fill in questionnaires related to risk level evaluation, to determine risk level indices of the users. However, the manner of questionnaire survey is inefficient and cannot ensure that the contents filled in by the users conform to their actual circumstances. Consequently, the risk level of each user cannot be determined accurately.

### SUMMARY

Accordingly, this application provides a method and an apparatus for determining a risk level of a user.

According to a first aspect of this application, a method for determining a risk level of a user is provided, including: obtaining first user data and second user data of a user, the first user data reflecting at least one user attribute related to a risk tolerance of the user, and the second user data being behavior data generated during a risk-related transaction of the user; determining, according to the first user data, a first index for representing the risk tolerance of the user; determining, according to the second user data, a second index for representing a risk preference degree of the user; and determining a user risk level of the user according to the first index and the second index. In some embodiments, the determining, according to the first user data, a first index for representing the risk tolerance of the user comprises: for each of the at least one user attribute, determining an attribute characteristic of the user according to the first user data; and inputting the attribute characteristic into a first machine classification model to determine an output of the first machine classification model as the first index for representing the risk tolerance of the user. In some embodiments, the determining, according to the second user data, a second index for representing a risk preference degree of the user comprises: for each of a plurality of specified variables, determining a characteristic value of the user according to the second user data, the plurality of specified variables comprising at least one specified variable that affects the risk preference degree of the user; and for each of the plurality of specified variables, inputting the characteristic value of the user into a second machine classification model, and determining an output of the second machine classification model as the second index for representing the risk preference degree of the user.

In some embodiments, the determining a user risk level of the user according to the first index and the second index comprises: determining a risk tolerance level of the user according to the first index; determining a risk preference degree level of the user according to the second index; and determining the user risk level of the user according to a predetermined level correspondence table, the level correspondence table being used for describing a correspondence among the risk tolerance level, the risk preference degree level, and the user risk level.

In some embodiments, the level correspondence table is determined through the following process: determining level numbers of risk tolerance levels, risk preference degree levels, and user risk levels respectively; and determining, based on the determined level numbers, a risk tolerance level and a risk preference degree level corresponding to each user risk level, to obtain the level correspondence table.

In some embodiments, the risk-related transaction comprises a transaction with a capital loss risk, and/or a transaction associated with a risky event.

In some embodiments, the at least one user attribute comprises: age, gender, family member, current life stage, income status, personal assets, family assets, and loan status.

In some embodiments, the risk-related transaction comprises: an investment and financing transaction with loss potential.

In some embodiments, the risk-related transaction comprises: a traffic violation fine payment.

In some embodiments, the risk-related transaction comprises: a physical examination fee payment.

According to a second aspect of this application, a method for determining a risk level of a user is provided, including: obtaining user data of a user for reflecting at least one user attribute, the user attribute being related to a risk tolerance of the user; for each of a plurality of user attributes, determining an attribute characteristic of the user according to the user data; determining, according to the attribute characteristic, a first index for representing the risk tolerance of the user; and determining a user risk level of the user according to the first index.

According to a third aspect of this application, an apparatus for determining a risk level of a user is provided, including: a first obtaining unit, configured to obtain first user data and second user data of a user, the first user data reflecting at least one user attribute related to a risk tolerance of the user, and the second user data being behavior data generated during a risk-related transaction of the user; a first determining unit, configured to determine, according to the first user data, a first index for representing the risk tolerance of the user; a second determining unit, configured to determine, according to the second user data, a second index for representing a risk preference degree of the user; and a risk level determining unit, configured to determine a user risk level of the user according to the first index and the second index.

According to a fourth aspect of this application, a computer device is provided, including: a processor; and a memory configured to store instructions executable by the processor; the processor is configured to: obtain first user data and second user data of a user, the first user data reflecting at least one user attribute related to a risk tolerance of the user, and the second user data being behavior data generated during a risk-related transaction of the user; determine, according to the first user data, a first index for representing the risk tolerance of the user; determine, according to the second user data, a second index for representing a risk preference degree of the user; and determine a user risk level of the user according to the first index and the second index.

According to a fifth aspect of this application, a system for determining a risk level of a user, comprising one or more processors and one or more non-transitory computer-readable memories coupled to the one or more processors and configured with instructions executable by the one or more processors to cause the system to perform operations comprising: obtaining first user data and second user data of a user, the first user data reflecting at least one user attribute related to a risk tolerance of the user, and the second user data being behavior data generated during a risk-related transaction of the user; determining, according to the first user data, a first index for representing the risk tolerance of the user; determining, according to the second user data, a second index for representing a risk preference degree of the user; and determining a user risk level of the user according to the first index and the second index.

According to a sixth aspect of this application, a non-transitory computer-readable storage medium for determining a risk level of a user, the storage medium configured with instructions executable by one or more processors to cause the one or more processors to perform operations comprising: obtaining first user data and second user data of a user, the first user data reflecting at least one user attribute related to a risk tolerance of the user, and the second user data being behavior data generated during a risk-related transaction of the user; determining, according to the first user data, a first index for representing the risk tolerance of the user; determining, according to the second user data, a second index for representing a risk preference degree of the user; and determining a user risk level of the user according to the first index and the second index.

It can be learned from the foregoing technical solutions that, in the foregoing process, by obtaining user data, determining a first index and/or a second index according to the obtained user data, and determining a risk level of a user according to the first index and/or the second index, the obtained risk level of the user is high in accuracy and high in efficiency.

### BRIEF DESCRIPTION OF THE DRAWINGS

FIG. 1 is a flowchart of a method for determining a risk level of a user according to some embodiments;

FIG. 2 is a process of training a machine classification model according to some embodiments;

FIG. 3 is a process of determining specified variables related to a risk preference degree of a user according to some embodiments;

FIG. 4 is a system architecture according to some embodiments; and

FIG. 5 is a hardware structure of an electronic device according to some embodiments.

### DETAILED DESCRIPTION

The disclosed embodiments provide a method for quickly and accurately measuring acceptance degrees or preference degrees of a user with respect to various possible risks. Using investment risks that a user is faced with during an investment and financing process, a user risk level of the user during investment and financing can be evaluated from two major aspects. One aspect is the subjective risk preference of the user, that is, whether the user psychologically prefers or is averse to investment risks, fluctuations, potential investment losses, and the like, and a degree of the preference or aversion. The second aspect is the objective risk tolerance of the user, that is, the measurement of impact from factors, such as investment risks and potential investment losses, on the actual life of the user, the life goal of the user, or the like. As for subjective risk preferences of users, different users have different risk preferences. Some users prefer purchasing high-risk high-return financial products (such as stocks and funds), and some users prefer purchasing low-risk low-return financial products (for example, third-party demand deposit financial products such as Yu'E Bao). To better serve a user, an Internet platform needs to evaluate a subjective risk preference degree of the user, so as to push suitable financial products to the user according to the risk preference degree of the user, or evaluate whether a financial product sold to the user is suitable for the user.

In related technologies, a user risk level is obtained by asking a user to fill in a questionnaire. Questions in the questionnaire include family members, an income status, a risk preference type, and the like. However, the questionnaire survey approach has at least one or more of the following disadvantages.

First, it is difficult to obtain a result consistent with the actual circumstance. This is mainly caused by the following factors: the content filled in by a user on the questionnaire is usually inconsistent with the actual circumstance of the user, and there is a possibility of subjectively cheating; or the user does not know how to answer some of the questions on the questionnaire, for example, the user may not know how to answer a question that asks how much percentage of loss the user can tolerate and the like.

Secondly, the form of the questionnaire is too simple. Data shows that results of questionnaire surveys are significantly different from actual behaviors conducted by users. In conclusion, the accuracy of results obtained through questionnaire surveys needs to be improved. In order to improve the accuracy, this application provides a method that can determine a risk level of a user more accurately and efficiently. This technical solution is described below through various embodiments.

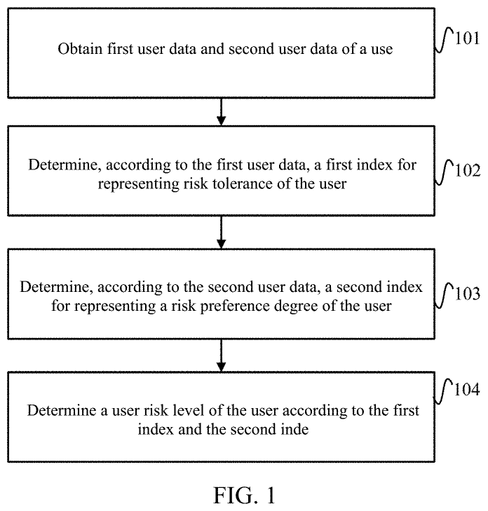

FIG. 1 depicts a process of a method for determining a risk level of a user according to an example of the embodiments. The method is applicable to a computer device (such as a platform server providing an investment and financing transaction, or a cloud computing platform). As shown in FIG. 1, in some embodiments, the method includes the following steps 101 to 104.

In step 101, first user data and second user data of a user is obtained, the first user data reflecting at least one user attribute related to a risk tolerance of the user, and the second user data being behavior data generated during a risk-related transaction of the user.

The first user data may be generated when the user uses various types of APPs. User attributes reflected by the first user data include, but are not limited to, age, gender, family member, current life stage, income status, personal assets, family assets, loan status, and the like of the user. Attribute characteristic of the various types of user attributes may be directly obtained by using data filled in by the user through the APP, or may be indirectly obtained by performing calculation on various types of user data. In the latter case, for example, the income of the user may be calculated according to a statement status of a bank card; the assets status of the user may be estimated according to the property and other assets owned by the user.

The transactions may be various services provided to users over the Internet, for example, living transactions such as self-service fee payment, and financial transactions such as investment and financing. In some embodiments, APPs providing the transactions can be developed, so that the user participates in these transactions through the APPs. Moreover, multiple risk-related transactions may be provided on the same APP. Such transactions usually involve risks, including the following situations. 1) The user may be faced with a risk after participating in the transaction; for example, the user may suffer a capital loss after participating in an investment and financing transaction. 2) A particular event related to the transaction is risky; for example, the user automatically pays a fee through a violation fine payment transaction, and the event related to the transaction is driving which involves risk; for another example, the user appoints a physical examination or makes an appointment with a doctor through a medical transaction, and the physical examination event or doctor appointment event is also related to a physical health risk of the user; and the like.

Various types of user data can be generated when the user executes the various risk-related transactions through the APP. In some embodiments, the user data may comprise behavior data corresponding to operation behaviors of the user. Using the investment and financing transaction as an example, operation behaviors of the user include, but are not limited to, searching for a particular type of information on the APP by the user, viewing a particular type of information on the APP by the user, commenting on a particular type of information on the APP by the user, and purchasing a particular type of financial product on the APP by the user. The operation behaviors of the user may occur at various stages of the investment, for example, before an investment occurs, during the investment, and after the investment is finished. The behavior data may include, but is not limited to, contents viewed by the user, a moment when the viewing action of the user occurs (a start moment or an end moment), duration of the viewing action, and the like. In some embodiments, the user data may also be reflected by other events related to the transaction, such as a driving event of the user (including the number of violations, violation types, and the like), a physical examination event of the user (including a time of the physical examination, items of the physical examination, and the like). The generated user data may be stored into a database, so that related user data can be obtained when the risk preference of the user needs to be determined.

After the foregoing step 101 is completed, the method proceeds to step 102 and step 103.

In step 102, a first index for representing the risk tolerance of the user is determined according to the first user data.

The risk tolerance of the user is mainly affected by the current life stage of the user and a wealth level of the user. In some embodiments, step 102 may be implemented through the following process.

Step 1021: For each of a plurality of user attributes, determine an attribute characteristic of the user according to the first user data.

Step 1022: Determine, according to the attribute characteristic, the first index for representing the risk tolerance of the user.

In some optional embodiments, in step 1022, the attribute characteristic may be input into a first machine classification model, and an output of the first machine classification model is determined as the first index for representing the risk tolerance of the user.

One or more intervals may be predetermined for each user attribute, and each interval corresponds to an attribute characteristic. For example, the user attribute is personal asset, and a plurality of intervals may be set as follows according to asset amount ranges: 0 to 500 thousand RMB, 500 thousand to 2 million RMB, 2 million to 10 million RMB, and the like. It may be determined that the attribute characteristic corresponding to 0 to 500 thousand RMB is “1” (representing a group with a low wealth level); it may be determined that the attribute characteristic corresponding to 500 thousand to 2 million RMB is “2” (representing a group with a medium wealth level), it may be determined that the attribute characteristic corresponding to 2 million to 10 million RMB is “3” (representing a group with a high wealth level). Likewise, the attribute characteristics of all of the user attributes can be determined according to the obtained first user data.

In some embodiments, the first index may be a risk tolerance level of the user. For example, in the dimension of risk tolerance, risk tolerance levels of users may be classified into five categories: low, medium to low, medium, medium to high, and high. An elder user with a low wealth level and high life pressure can be classified into the category of “low”. A young user with a high wealth level and low life pressure can be classified into the category of “high”; the other three categories are users between “low” and “high”. The first index may also be a value (which may range from 0 to 1) for representing the risk tolerance of the user, where a larger value indicates a higher risk tolerance of the user.

The first machine classification model may be obtained through training based on a machine learning algorithm.

In other embodiments, an influence coefficient corresponding to each user attribute may also be determined according to personal experiences, and the final first index is obtained by calculating a weighted sum of all the determined influence coefficients.

In step 103, a second index for representing a risk preference degree of the user is determined according to the second user data.

In some embodiments, step 103 may be implemented through the following process.

Step 1031: For each of a plurality of specified variables, determine a characteristic value of the user according to the second user data, the specified variables including at least one specified variable that affects the risk preference degree of the user.

In some embodiments, not all of the second user data generated during the risk-related transaction can reflect the risk preference degree of the user, that is, not all data is associated with the risk preference degree of the user. In some embodiments, a part of the second user data is associated with the risk preference degree of the user, and this part of data is the target data that needs to be obtained during determining of the risk preference of the user. For example, the physical examination event of the user can reflect the attitude of the user when facing a health risk. According to a conventional understanding, this can reflect the attitude of the user towards other types of risks, and therefore, some data corresponding to the physical examination event may be associated with the risk preference degree of the user.

Therefore, one or more specified variables that can affect the risk preference degree of the user may be configured. Using an information search behavior of the user as an example, if most searches by the user in the APP includes terms such as “stock” or “fund”, or the types of financial products searched for by the user are “stock” or “fund”, it can reflect to a certain extent that the user prefers high risks (that is, the user has a high degree of preference for the investment risk). On the contrary, if the frequent searches by the user are low-risk financial products, it can reflect that the user prefers low risks (that is, the user has a low degree of preference for the investment risk). In this example, the specified variable corresponding to the search behavior is “type of the search content.” Correspondingly, for each content type, a characteristic value (that is, a value assigned to the specified variable) corresponding to the content type may be predetermined. For example, content types are classified into a high risk type, a medium risk type, and a low risk type, where a characteristic value corresponding to the high risk type is 1, a characteristic value corresponding to the medium risk type is 0.5, and a characteristic value corresponding to the low risk type is 0. Using an information viewing behavior of the user as an example, if a user A needs to view 100 other financial products before purchasing a financial product X, and a user B needs to view 10 other financial products before purchasing a financial product X, it indicates that the user A is more rational towards investment risk, and the user B does not care much about investment risk. In other words, the risk preference degree of the user A is lower than the risk preference degree of the user B. In this example, the specified variable is the quantity of financial products viewed by the user before an investment occurs. There are various types of specified variables, which are not listed one by one herein.

In some embodiments, a plurality of candidate specified variables may be predefined, and it is verified, through a related technical means, whether the candidate specified variables are correlated to the degree of preference of the user for the investment risk one by one. A specified variable correlated to the risk preference degree of the user is selected. A process of how to obtain, through verification, a specified variable correlated to the risk preference degree of the user is described in detail below.

In some embodiments, the plurality of specified variables may include some specified variables that have no influence or a small influence on (or a low correlation to) the risk preference degree of the user. For example, an influence coefficient of such specified variables may be set to 0 or a value close to 0.

User data generated by operations of the user when using the APP is a statistical value. In some optional embodiments, in order to calculate a risk preference index of the user more accurately, a plurality of statistical value intervals may be preset for each specified variable, and a characteristic value of a target user for each specified variable may be determined by using the statistical value intervals. By using the quantity of high-risk financial products viewed by the user before investment as an example, three statistical value intervals: 1 to 10, 10 to 20, and 20 to 50, may be defined in advance; besides, it is defined that characteristic values corresponding to the three statistical value intervals are 0.1, 0.2, and 0.3 respectively. Then, when the quantity of high-risk financial products viewed by a user before investment is between 1 and 10, the characteristic value of the specified variable is 0.1; when the quantity of high-risk financial products viewed by a user before investment is between 10 and 20, the characteristic value of the specified variable is 0.2; when the quantity of high-risk financial products viewed by a user before investment is between 20 and 50, the characteristic value of the specified variable is 0.3. Similarly, characteristic values of other types of specified variables can be determined according to this rule.

It is conceivable that the user faces many types of risks in life (including investment and financing risks and non-investment risks). In order to more accurately determine the risk preference index that can measure the level of the risk preference degree of the user, behavior data of the user facing various types of risks need to be obtained as much as possible, and the level of the risk preference degree of the user is determined according to choices or operations made by the user facing various types of risks. For example, the non-investment risks include, but are not limited to, occupational risks of the user, physical health risks of the user, risks when the user participates in sports, risks when the user drives, risks in other financial scenarios, and the like. When the user faces occupational risks, the specified variables may include: whether the user chooses self-employment or works in a highly stable industry such as bank or government, or a job-switching frequency of the user. When the user faces physical health risks, the specified variables may include a physical examination frequency or stability of the user, or a health care product purchasing status of the user, and the like. When the user participates in sports, the specified variables may include: whether the user likes taking part in high-risk sports, such as mountain-climbing and skiing, and whether the user likes taking part in low-risk sports, such as fishing. When the user faces risks during driving, the specified variables may include: a driving speed of the user, whether the user often drives over the speed limit, or the number of violations, and the like. When the user is in other financial scenarios, the specified variables may include: whether the user purchases sufficient insurance to prepare for the future, whether the user prefers using a credit card for payment, making payments in advance, making payments with a deposit card, or the like. User data related to the foregoing types of risks may also be obtained from a backend database corresponding to the APP providing the related transactions.

One or more specified variables may be designed for other non-investment risks, and it is verified, through a related technical means, whether each specified variable is a specified variable correlated to the risk preference degree of the user one by one.

Step 1032: Input the characteristic value of the user for each specified variable into a second machine classification model, and determine an output of the second machine classification model as the second index for representing the risk preference degree of the user.

In some embodiments, an influence coefficient may be predetermined for each specified variable. Then, a process of calculating the risk preference index is as follows: first multiplying the characteristic value of each specified variable by the influence coefficient corresponding to the specified variable, then adding up all the products, and determining a sum of the products as the risk preference index of the user.

In other embodiments, a machine classification model may be trained in advance. Then, in step 103, the characteristic value of the user for each specified variable is input into the machine classification model, and an output of the machine classification model is determined as the risk preference index of the user. The input of the machine classification model is the characteristic value for each of the plurality of specified variables, and the output of the machine classification model is a possibility that the user is classified into a high risk preference type. If users with the lowest risk preference degree are defined as “users of a low risk preference type”, and users with the highest risk preference degree are defined as “users of a high risk preference type”, the risk preference index corresponding to the “users of a low risk preference type” is equal to or infinitely close to 0, and the risk preference index corresponding to “users of a high risk preference type” is equal to or infinitely close to 1. If the risk preference index of a user is closer to 0, it indicates that the user is more likely to belong to the “users of a low risk preference type”; if the risk preference index of a user is closer to 1, it indicates that the user is more likely to belong to the “users of a high risk preference type”.

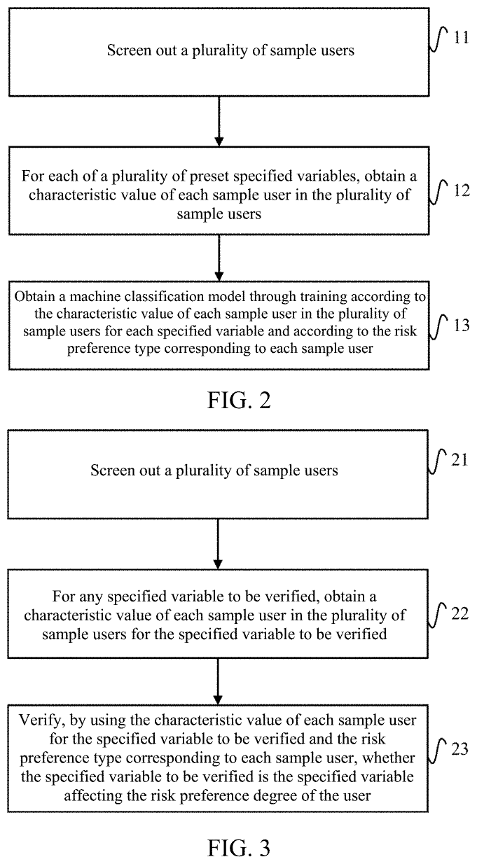

FIG. 2 is a process of training a machine classification model according to an example of some embodiments. As shown in FIG. 2, in some optional embodiments, in order to improve the accuracy, the machine classification model can be trained through the following process.

Step 11: Screen out a plurality of sample users, the plurality of sample users including a plurality of sample users of a high risk preference type and a plurality of sample users of a low risk preference type.

Sample users belonging to the high risk preference type may not care about or even prefer risks or losses during investment. On the contrary, sample users belonging to the low risk preference type may be extremely averse to risks during investment, and avoid losses as far as possible. In some embodiments, the two types of samples are significantly different in terms of behaviors.

The process of screening out a plurality of sample users can be implemented in many manners. Two implementation manners are provided herein.

In some embodiments, step 11 may be implemented through the following process.

Based on a high risk preference rule and a low risk preference rule as defined, users whose user data conforms to the high risk preference rule are determined as sample users of the high risk preference type, and users whose user data conforms to the low risk preference rule are determined as sample users of the low risk preference type. Different from a conventional definition, the definitions of the rules do not rely on whether the user purchases a high-risk product. The definitions of the related rules herein are based on related theories in psychology, behavioral finance, and decision science. For example, a risk preference type to which a user belongs is defined by considering a psychological state and an actual behavior of the user when facing a loss. In this scenario, a defined “high risk preference rule” may be “continuing to purchase regardless of the loss”. For example, a user continues to purchase a certain amount of high-risk product when a capital loss percentage is greater than or equal to 20% or a loss amount is greater than or equal to 500 RMB. A defined “low risk preference rule” may be “being afraid of checking asset losses”, that is, a user who frequently checks the profit status of personal assets when there is a profit in the account becomes afraid of checking the balance status of the personal assets when a significant loss is generated in the account. For another example, a risk preference type to which a user belongs is defined by considering a psychological state and an actual behavior of the user during fluctuations. In this scenario, a defined “low risk preference rule” is “being more sensitive during fluctuations”, that is, a user who does not care about his/her assets when the stock market is stable frequently logs in to check his/her assets each time the stock market fluctuates significantly (for example, declines by 1%). In order to improve the accuracy of the screened-out sample users, many different “high risk preference rules” and many different “low risk preference rules” may be defined, and various sample users conforming to the rules are screened out by using these rules and existing user data, and a “high risk preference” or “low risk preference” type tag is assigned to each sample user.

In other embodiments, step 11 may be implemented through the following process.

Based on an experimental application for testing risk preferences of users as well as a high risk preference rule and a low risk preference rule as defined, users whose behaviors in the experimental application conform to the high risk preference rule are determined as sample users of the high risk preference type, and users whose behaviors in the experimental application conform to the low risk preference rule are determined as sample users of the low risk preference type. For example, a “balloon blowing” game is developed, in which the user's task is to blow a balloon continuously to obtain an amount of money positively correlated to the size of the blown balloon. Like a balloon in real life, the balloon will explode if the user blows the balloon too big (the more the user blows, the bigger the balloon becomes). However, it is unknown at which size the balloon will explode. The user has to choose to blow one more time or exit in each round of the game. If the user chooses to blow the balloon, there are two possible results: 1) the balloon becomes bigger, and the user gets more money; and 2) the balloon explodes, and the money already obtained is lost. If the user chooses to exit, the user can obtain money accumulated so far. In this game, users who blow the balloon for more than a quantity threshold a (e.g., a specified value) may be defined as users with a high risk preference, users who blow the balloon for less than another quantity threshold b (specified value) may be defined as users with a low risk preference, and users who blow the balloon for a number of times between a and b are defined as indefinite users. There may be other types of experimental games for obtaining the samples, which are not listed one by one herein.

Step 12: For each of a plurality of preset specified variables, obtain a characteristic value of each sample user in the plurality of sample users. The characteristic value may be determined according to user data of each sample user. The specified variables herein are various pre-designed variables potentially correlated to the risk preference.

Step 13: Obtain a machine classification model through training according to the characteristic value of each sample user in the plurality of sample users for each specified variable and according to the risk preference type corresponding to each sample user, where an input of the machine classification model is the characteristic value for each of the plurality of specified variables, and an output of the machine classification model is a possibility that the user is classified into the high risk preference type. Machine learning methods used for training the model may include, but are not limited to, linear regression, logistic regression, and the like.

After the machine classification model is obtained for later use through training, the characteristic value of the target user for each specified variable can be input into the machine classification model, so as to output the risk preference index of the target user. Risk preference degrees of users may be classified into multiple levels as required, for example, low, medium, and high. Moreover, the level of the risk preference degree of the user is determined according to the output risk preference index. For example, when the risk preference index is between 0 and 0.3, the level of the risk preference degree is “low”; when the risk preference index is between 0.3 and 0.6, the level of the risk preference degree is “medium”; when the risk preference index is between 0.6 and 1, the level of the risk preference degree is “high”.

As for how to determine the specified variable that affects the risk preference degree of the user, in some embodiments, verifications can be performed by using the determined sample users above. As shown in FIG. 3, the specified variable affecting the risk preference degree of the user can be determined through the following process.

Step 21: Screen out a plurality of sample users, the plurality of sample users including a plurality of sample users of a high risk preference type and a plurality of sample users of a low risk preference type.

Step 22: For any specified variable to be verified, obtain a characteristic value of each sample user in the plurality of sample users for the specified variable to be verified.

Step 23: Verify, by using the characteristic value of each sample user for the specified variable to be verified and the risk preference type corresponding to each sample user, whether the specified variable to be verified is the specified variable affecting the risk preference degree of the user.

In some optional embodiments, step 23 may be implemented through the following process:

Step 231: Determine, based on the characteristic value of each sample user for the specified variable to be verified, a characteristic value pattern of the plurality of sample users of the high risk preference type for the specified variable to be verified and a characteristic value pattern of the plurality of sample users of the low risk preference type for the specified variable to be verified. For example, the characteristic value pattern includes an average value obtained by averaging the plurality of characteristic values, or a distribution interval of the plurality of characteristic values.

Step 232: If a difference between the characteristic value pattern corresponding to the high risk preference type and the characteristic value pattern corresponding to the low risk preference type meets a specified condition, determine the specified variable to be verified as the specified variable affecting the risk preference degree of the user.

For a specified variable affecting the risk preference degree, the characteristic value patterns corresponding to the user samples of the “high risk preference type” and the “low risk preference type” are significantly different over the specified variable. On the contrary, if a specified variable does not affect the risk preference degree of the user, the characteristic value patterns corresponding to the user samples of the “high risk preference type” and the “low risk preference type” are only slightly different or even the same over the specified variable. Therefore, a specified condition for measuring the difference can be set, to determine whether the difference between the characteristic value patterns corresponding to the user samples of the “high risk preference type” and the “low risk preference type” over the specified variable meet the specified condition, so as to determine a specified variable meeting the condition.

For example, if the specified variable to be verified is “the quantity of financial products viewed by the user before an investment behavior occurs”, it is assumed that characteristic values of eight user samples of the “high risk preference type”, which are screened out in advance, for the specified variable are as follows:

{3, 1, 4, 10, 5, 6, 1, 31}

It is assumed that characteristic values of eight user samples of the “low risk preference type”, which are screened out in advance, for the specified variable are as follows:

{9, 6, 7, 10, 13, 8, 8, 11}

The defined specified condition is that a difference between an average value x of all the characteristic values of the user samples of the “high risk preference type” for the specified variable and an average value y of all the characteristic values of the user samples of the “low risk preference type” for the specified variable is greater than 4.

Then, it is obtained through calculation that x=4.15, and y=9. It can be learned that the foregoing specified condition is met, it can be determined that “the quantity of financial products viewed by the user before an investment behavior occurs” is a specified variable affecting the risk preference degree of the user.

In other optional embodiments, the foregoing step 23 may also be implemented through the following process: collecting statistics about a distribution of characteristic values greater than a specified threshold in the plurality of sample users, and determining, according to the distribution, whether the specified variable is a specified variable affecting the risk preference degree of the user.

For example, in the foregoing example, if the specified threshold is 5, it is obtained through statistics that the distribution of characteristic values greater than 5 is as follows: two sample users of the “high risk preference type” and eight sample users of the “low risk preference type”. It can be learned that the distribution of the characteristic values corresponding to the specified variable on the two types of sample users is non-uniform, which indicates that the specified variable has a great influence on the risk preference of the user, and can be determined as a specified variable affecting the risk preference degree of the user.

In other optional embodiments, one or more specified variables affecting the risk preference degree of the user may be designed according to personal experience.

After the foregoing step 102 and step 103 are completed, the method proceeds to step 104.

In step 104, a user risk level of the user is determined according to the first index and the second index.

In some embodiments, the first index and the second index may be scores (for example, between 0 and 1) for reflecting the risk tolerance and the risk preference degree respectively. In some embodiments, a higher score can represent a higher risk tolerance or a higher risk preference degree.

In some embodiments, the foregoing step 104 may be implemented through the following process: determining a risk tolerance level of the user according to the first index, where the risk tolerance of the users can be classified into a plurality of levels from low to high, and each level may correspond to a value interval about the first index; determining a risk preference degree level of the user according to the second index, where similarly, the risk preference degrees of the users can be classified into a plurality of levels from low to high, and each level may correspond to a value interval about the second index; and determining the user risk level of the user according to a predetermined level correspondence table, the level correspondence table being used for describing a correspondence among the risk tolerance level, the risk preference degree level, and the user risk level. In the embodiments of this application, according to general requirements, the risk tolerance level and the risk preference degree level need to be merged to obtain a final user risk level that can reflect the risk level of the user in terms of investment. In some embodiments, a higher risk tolerance level or a higher risk preference degree level of a user indicates a higher user risk level of the user.

In some embodiments, the foregoing level correspondence table may be determined through the following process.

Level numbers of risk tolerance levels, risk preference degree levels, and user risk levels are determined respectively. The level numbers of the levels may be set manually according to actual requirements. Alternatively, the level numbers corresponding to the levels are determined by a computer according to a predetermined rule. For example, the level numbers related to the levels are determined according to the number of users of a platform. It may be defined that, the level numbers increase when the quantity of users of the platform exceeds a particular value; alternatively, it is defined that the level number corresponding to the user risk levels is not less than the level numbers corresponding to the risk tolerance levels and the risk preference degree levels, and the like.

A risk tolerance level and a risk preference degree level corresponding to each user risk level are determined based on the determined level numbers, to obtain the level correspondence table.

After the level numbers corresponding to all types of levels are set, a risk tolerance level and a risk preference degree level corresponding to each user risk level can be determined. Similarly, the risk tolerance level and the risk preference degree level corresponding to each user risk level may be determined manually, or determined by a computer according to a predetermined rule. The predetermined rule is, for example, for the number of times each user risk level appears in the table, the medium level can appear in the table for more times than a high level or a low level, and the like.

In other embodiments, corresponding weights may be set for the “risk preference degree” and the “risk tolerance” respectively. A score (the score can reflect a value of the final user risk level) corresponding to each combination of a risk preference degree level and a risk tolerance level is calculated according to the pre-divided risk preference degree levels and risk tolerance levels and with reference to the foregoing weights. All the scores can be calculated, thereby determining a user risk level corresponding to each combination. The process of determining the level correspondence table is not limited herein. The correspondence among levels may not be present in the form of a table.

For example, the level correspondence table is shown as Table 1 below:

TABLE 1

| | | Risk preference degree | | | | |
|---|---|---|---|---|---|---|
| | | | Medium | | Medium | |
| User risk level | | Low | to low | Medium | to high | High |
| Risk | Low | 0 | 0 | 1 | 1 | 2 |
| tolerance | Medium to low | 1 | 1 | 2 | 3 | 3 |
| | Medium | 2 | 2 | 3 | 4 | 4 |
| | Medium to high | 3 | 3 | 4 | 5 | 5 |
| | High | 4 | 4 | 5 | 5 | 6 |

If the risk tolerance is used as a primary factor and the risk preference degree is used as an auxiliary factor, that is, with the same risk tolerance level, a higher risk preference degree level indicates a higher user risk level; and with the same risk preference degree level, a higher risk tolerance level indicates a higher user risk level, according to this principle, the user risk levels can be divided into 7 levels from 0 to 6. “0” represents users with the lowest user risk level, whose risk preference degree is the lowest and risk tolerance is also the lowest. “6” represents users with the highest user risk level, whose risk tolerance is the highest and risk preference degree level is also the highest.

During actual implementations, the foregoing process of calculating the user risk level may be performed at intervals of a particular time length (for example, every day). The latest user data is obtained every day to determine a user risk level, to ensure that data can be updated in time.

In other embodiments, a method for determining a risk level of a user is further provided, including: obtaining user data of a user for reflecting at least one user attribute, the user attribute being related to a risk tolerance of the user; for each of a plurality of user attributes, determining an attribute characteristic of the user according to the user data; determining, according to the attribute characteristic, a first index for representing the risk tolerance of the user; and determining a user risk level of the user according to the first index.

In the embodiments, only user data for determining the risk tolerance of the user may be obtained, the risk tolerance of the user is determined according to the user data, and the user risk level is determined according to the first index.

It can be learned from the foregoing technical solution that, in the foregoing process, by obtaining user data, determining a first index and/or a second index according to the obtained user data, and determining a risk level of a user according to the first index and/or the second index, the obtained risk level of the user is high in accuracy and high in efficiency. Moreover, it can also be ensured that the data is updated in time.

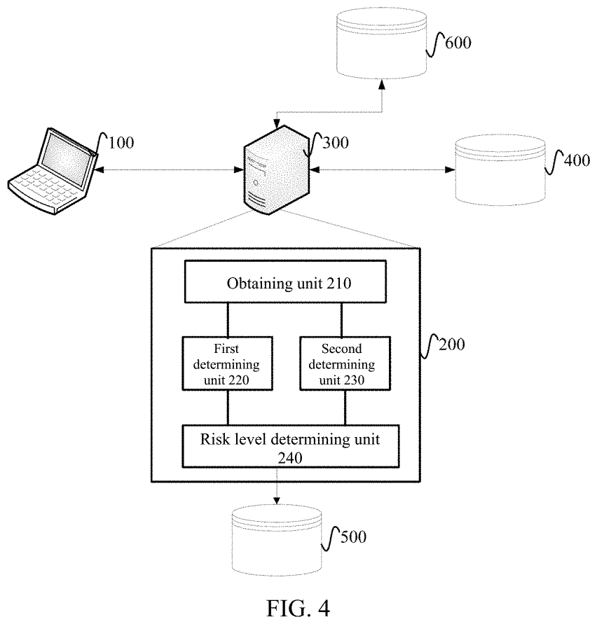

FIG. 4 shows a system architecture. In some embodiments, the system may include: a user device 100, a server 300 interacting with the user device, a first database 400 connected to the server 300, an apparatus 200 for determining a risk level of a user, a second database 500, and a third database 600. An APP providing an investment and financing transaction may be installed on the user device 100. The server 300 is a platform server end corresponding to the APP. The platform server end stores, in the first database 400, second user data that is generated when a user participates in a risk-related transaction, so that the second user data can be obtained by the apparatus 200 for determining a risk level of a user. First user data that can affect risk tolerance of the user may be stored in the third database 600, and the first user data can be obtained by the apparatus 200 for determining a risk level of a user. Data in the third database 600 may be directly written by the server 300, or collected and written by other application servers, which is not limited herein. The apparatus 200 for determining a risk level of a user may be a virtual apparatus that exists on the server 300 in the form of program code. In some embodiments, the apparatus 200 may also exist on another computer apparatus. When a risk level of a user needs to be determined, the apparatus 200 obtains required second user data from the first database 400, extracts characteristic values of specified variables, and inputs the characteristic values into a machine classification model provided in advance, so that a second index (representing a risk preference of the user) is output. The apparatus 200 can further obtain required first user data from the third database 600, extract attribute characteristics, and input the attribute characteristics into a preset machine classification model, so that a first index (representing risk tolerance of the user) is output. The apparatus 200 determines a user risk level according to the first index and the second index and stores the user risk level in the second database 500, so that the user risk level can be called in various application scenarios. At least some of the foregoing databases may be the same database, which is not limited herein.

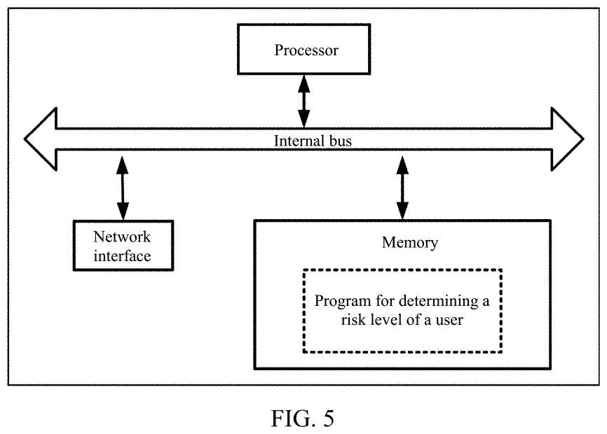

FIG. 5 shows a structure of an electronic device according to an example of some embodiments. As shown in FIG. 5, the electronic device may be a computer device (such as a payment platform server or a financing platform server). The electronic device may include a processor, an internal bus, a network interface, and storage (including memory and non-volatile storage), and may further include other hardware required by transactions. The processor reads a corresponding computer program from the non-volatile storage into the memory and then runs the computer program. In addition to a software implementation, this application does not exclude other implementations, for example, a logic device or a combination of software and hardware. In other words, an entity executing the following processing procedure is not limited to the logic units, and may also be hardware or logic devices.

In some embodiments, referring to FIG. 4, the apparatus 200 for determining a risk level of a user may include: an obtaining unit 210, configured to obtain first user data and second user data of a user, the first user data reflecting at least one user attribute related to a risk tolerance of the user, and the second user data being behavior data generated during a risk-related transaction of the user; a first determining unit 220, configured to determine, according to the first user data, a first index for representing the risk tolerance of the user; a second determining unit 230, configured to determine, according to the second user data, a second index for representing a risk preference degree of the user; and a risk level determining unit 240, configured to determine a user risk level of the user according to the first index and the second index.

In some optional embodiments, the first determining unit 220 includes: an attribute characteristic determining unit, configured to, for each of a plurality of user attributes, determine an attribute characteristic of the user according to the first user data; and a first calculation unit, configured to input the attribute characteristic into a first machine classification model to determine an output of the first machine classification model as the first index for representing the risk tolerance of the user.

In some optional embodiments, the second determining unit 230 includes: a characteristic value determining unit, configured to, for each of a plurality of specified variables, determine a characteristic value of the user according to the second user data, the specified variables including at least one specified variable that affects the risk preference degree of the user; and a second calculation unit, configured to input the characteristic value of the user for each specified variable into a second machine classification model, and determine an output of the second machine classification model as the second index for representing the risk preference degree of the user.

In some optional embodiments, the risk level determining unit 240 includes: a first level determining unit, configured to determine a risk tolerance level of the user according to the first index; a second level determining unit, configured to determine a risk preference degree level of the user according to the second index; and a third level determining unit, configured to determine the user risk level of the user according to a predetermined level correspondence table, the level correspondence table being used for describing a correspondence among the risk tolerance level, the risk preference degree level, and the user risk level; and determine a correspondence between the user risk level and the predetermined risk tolerance level as well as the risk preference level according to the predetermined risk tolerance level

In some optional embodiments, the apparatus further includes: a level number determining unit, configured to determine level numbers of risk tolerance levels, risk preference degree levels, and user risk levels respectively; and a level correspondence table determining unit, configured to determine, based on the determined level numbers, a risk tolerance level and a risk preference degree level corresponding to each user risk level, to obtain the level correspondence table.

In some optional embodiments, the risk-related transaction includes a transaction with a capital loss risk, and/or a transaction associated with a risky event.

In some embodiments, an apparatus for determining risk tolerance of a user is further provided, including: an obtaining unit, configured to obtain user data of a user for reflecting at least one user attribute, the user attribute affecting risk tolerance of the user; a third determining unit, configured to, for each of a plurality of user attributes, determine an attribute characteristic of the user according to the user data; and a fourth determining unit, configured to determine, according to the attribute characteristic, a first index for representing the risk tolerance of the user.

In some embodiments, the various modules and units of the apparatus for determining a risk level of a user may be implemented as software instructions or a combination of software and hardware. For example, the apparatus 200 (or referred to as a system) for determining a risk level of a user described with reference to FIG. 4 may comprise one or more processors (e.g., a CPU) and one or more non-transitory computer-readable storage memories coupled to the one or more processors and configured with instructions executable by the one or more processors to cause one or more components (e.g., the one or more processors) of the system to perform various steps and methods of the modules and units described above (e.g., with reference to the method embodiments). In some embodiments, the apparatus for determining a risk level of a user may include a server, a mobile phone, a tablet computer, a PC, a laptop computer, another computing device, or a combination of one or more of these computing devices.

In some embodiments, a computer storage medium with a computer program stored thereon is further provided, and the following steps are implemented when the computer program is executed by a processor: obtaining first user data and second user data of a user, the first user data reflecting at least one user attribute related to a risk tolerance of the user, and the second user data being behavior data generated during a risk-related transaction of the user; determining, according to the first user data, a first index for representing the risk tolerance of the user; determining, according to the second user data, a second index for representing a risk preference degree of the user; and determining a user risk level of the user according to the first index and the second index.

In some embodiments, a computer storage medium with a computer program stored thereon is further provided, and the following steps are implemented when the computer program is executed by a processor: obtaining user data of a user for reflecting at least one user attribute, the user attribute affecting risk tolerance of the user; for each of a plurality of user attributes, determining an attribute characteristic of the user according to the user data; and determining, according to the attribute characteristic, a first index for representing the risk tolerance of the user.

In some embodiments, a computer device is further provided, including: a processor; and a memory configured to store instructions executable by the processor; where the processor is configured to: obtain first user data and second user data of a user, the first user data reflecting at least one user attribute related to a risk tolerance of the user, and the second user data being behavior data generated during a risk-related transaction of the user; determine, according to the first user data, a first index for representing the risk tolerance of the user; determine, according to the second user data, a second index for representing a risk preference degree of the user; and determine a user risk level of the user according to the first index and the second index.

In some embodiments, a computer device is further provided, including: a processor; and a memory configured to store instructions executable by the processor; where the processor is configured to: obtain user data of a user for reflecting at least one user attribute, the user attribute being related to a risk tolerance of the user; for each of a plurality of user attributes, determine an attribute characteristic of the user according to the user data; determine, according to the attribute characteristic, a first index for representing the risk tolerance of the user; and determine a user risk level of the user according to the first index.

The embodiments of the present disclosure are all described in a progressive manner. For the same or similar parts in the embodiments, reference may be made to these embodiments. Each embodiment focuses on a difference from other embodiments. In some embodiments, a computer device embodiment, an apparatus embodiment, or a computer storage medium embodiment is basically similar to a method embodiment, and therefore is described briefly; for related parts, reference may be made to some descriptions in the method embodiment.

The system, the apparatus, the module or the unit described in the foregoing embodiments can be implemented by a computer chip or an entity or implemented by a product having a certain function. A typical implementation device is a computer, and the form of the computer may be a personal computer, a laptop computer, a cellular telephone, a camera phone, a smartphone, a personal digital assistant, a media player, a navigation device, an email transceiver device, a game console, a tablet computer, a wearable device, or a combination thereof.

For ease of description, when the apparatus is described, the apparatus is divided into units according to functions, which are separately described. In some embodiments, during implementation of this application, the function of the units may be implemented in the same or multiple pieces of software and/or hardware.

A person skilled in the art should understand that the embodiments of the present application may be provided as a method, a system, or a computer program product. Therefore, the each embodiment may be in a form of complete hardware embodiments, complete software embodiments, or embodiments combining software and hardware. Moreover, the each embodiment may use a form of a computer program product that is implemented on one or more computer-usable storage media (including but not limited to a disk memory, a CD-ROM, an optical memory, and the like) that include computer-usable program code.

The present application is described with reference to the flowcharts and/or block diagrams of the method, the device (system), and the computer program product according to the embodiments of the present application. Computer program instructions may be used for implementing each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a function in one or more processes in the flowcharts and/or in one or more blocks in the block diagrams.

These computer program instructions may further be stored in a computer readable memory that can instruct the computer or any other programmable data processing device to work in a specific manner, so that the instructions stored in the computer readable memory generate an artifact that includes an instruction apparatus. The instruction apparatus implements a specified function in one or more processes in the flowcharts and/or in one or more blocks in the block diagrams.

These computer program instructions may further be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, the computer device includes one or more processors (CPUs), an input/output interface, a network interface, and a memory.

The memory may include, among computer readable media, a non-persistent memory such as a random access memory (RAM) and/or a non-volatile memory such as a read-only memory (ROM) or a flash memory (flash RAM). The memory is an example of the computer-readable medium.

The computer-readable medium includes persistent, non-persistent, movable, and unmovable media that may implement information storage by using any method or technology. Information may be a computer-readable instruction, a data structure, a program module, or other data. Examples of computer storage media include but are not limited to a phase change memory (PRAM), a static random access memory (SRAM), a dynamic random access memory (DRAM), other type of random access memory (RAM), a read-only memory (ROM), an electrically erasable programmable read-only memory (EEPROM), a flash memory or other memory technology, a compact disc read-only memory (CD-ROM), a digital versatile disc (DVD) or other optical storage, a cassette magnetic tape, tape and disk storage or other magnetic storage device or any other non-transmission media that may be configured to store information that a computing device can access. Based on the definition in the present disclosure, the computer-readable medium does not include transitory computer readable media (transitory media), such as a modulated data signal and a carrier.

The terms “include”, “comprise”, and any other variants thereof mean to cover the non-exclusive inclusion. Thereby, the process, method, article, or device which includes a series of elements not only includes those elements, but also includes other elements which are not expressly listed, or includes the inherent elements of the process, method, article, or device. Without further limitation, the element defined by a phrase “include one . . . ” does not exclude other similar elements in the process, method, article or device which include the element.

A person skilled in the art should understand that the embodiments of this application may be provided as a method, a system, or a computer program product. Therefore, this application may use a form of hardware only embodiments, software only embodiments, or embodiments with a combination of software and hardware. Moreover, this application may use a form of a computer program product that is implemented on one or more computer-usable storage media (including but not limited to a disk memory, a CD-ROM, an optical memory, and the like) that include computer-usable program code.

This application can be described in the general context of computer executable instructions executed by a computer, for example, a program module. The program module includes a routine, a program, an object, a component, a data structure, and the like for executing a particular task or implementing a particular abstract data type. This application can also be practiced in a distributed computing environment in which tasks are performed by remote processing devices that are connected through a communication network. In a distributed computing environment, the program module may be located in both local and remote computer storage media including storage devices.

The foregoing descriptions are merely embodiments of this application and are not intended to limit this application. For a person skilled in the art, various modifications and variations can be made to this application. Any modification, equivalent replacement, or improvement made without departing from the spirit and principle of this application shall fall within the scope of the claims of this application.

What is claimed is:

1. A method for determining a risk level of a user, comprising:
obtaining first user data and second user data of a user, the first user data reflecting at least one user attribute related to a risk tolerance of the user, and the second user data being behavior data generated during a risk-related transaction of the user;
determining, according to the first user data, a first index for representing the risk tolerance of the user;
determining, according to the second user data, a second index for representing a risk preference degree of the user; and
determining a user risk level of the user according to the first index and the second index.

2. The method according to claim 1, wherein the determining, according to the first user data, a first index for representing the risk tolerance of the user comprises:
for each of a plurality of user attributes, determining an attribute characteristic of the user according to the first user data; and
inputting the attribute characteristic into a first machine classification model to determine an output of the first machine classification model as the first index for representing the risk tolerance of the user.

3. The method according to claim 1, wherein the determining, according to the second user data, a second index for representing a risk preference degree of the user comprises:
for each of a plurality of specified variables, determining a characteristic value of the user according to the second user data, the plurality of specified variables comprising at least one specified variable that affects the risk preference degree of the user; and
for each of the plurality of specified variables, inputting the characteristic value of the user into a second machine classification model, and determining an output of the second machine classification model as the second index for representing the risk preference degree of the user.

4. The method according to claim 1, wherein the determining a user risk level of the user according to the first index and the second index comprises:
determining a risk tolerance level of the user according to the first index;
determining a risk preference degree level of the user according to the second index; and determining the user risk level of the user according to a predetermined level correspondence table, the level correspondence table being used for describing a correspondence among the risk tolerance level, the risk preference degree level, and the user risk level.

5. The method according to claim 4, wherein the level correspondence table is determined through the following process:
determining level numbers of risk tolerance levels, risk preference degree levels, and user risk levels respectively; and
determining, based on the determined level numbers, a risk tolerance level and a risk preference degree level corresponding to each user risk level, to obtain the level correspondence table.

6. The method according to claim 1, wherein the risk-related transaction comprises a transaction with a capital loss risk, and/or a transaction associated with a risky event.

7. The method according to claim 1, wherein the at least one user attribute comprises:
age, gender, family member, current life stage, income status, personal assets, family assets, and loan status.

8. The method according to claim 1, wherein the risk-related transaction comprises:
an investment and financing transaction with loss potential.

9. The method according to claim 1, wherein the risk-related transaction comprises:
a traffic violation fine payment.

10. The method according to claim 1, wherein the risk-related transaction comprises:
a physical examination fee payment.

11. A system for determining a risk level of a user, comprising one or more processors and one or more non-transitory computer-readable memories coupled to the one or more processors and configured with instructions executable by the one or more processors to cause the system to perform operations comprising:
obtaining first user data and second user data of a user, the first user data reflecting at least one user attribute related to a risk tolerance of the user, and the second user data being behavior data generated during a risk-related transaction of the user;
determining, according to the first user data, a first index for representing the risk tolerance of the user;
determining, according to the second user data, a second index for representing a risk preference degree of the user; and
determining a user risk level of the user according to the first index and the second index.

12. The system of claim 11, wherein the determining, according to the first user data, a first index for representing the risk tolerance of the user comprises:
for each of the at least one user attribute, determining an attribute characteristic of the user according to the first user data; and
inputting the attribute characteristic into a first machine classification model to determine an output of the first machine classification model as the first index for representing the risk tolerance of the user;

13. The system according to claim 11, wherein the determining, according to the second user data, a second index for representing a risk preference degree of the user comprises:
for each of a plurality of specified variables, determining a characteristic value of the user according to the second user data, the plurality of specified variables comprising at least one specified variable that affects the risk preference degree of the user; and
for each of the plurality of specified variables, inputting the characteristic value of the user into a second machine classification model, and determining an output of the second machine classification model as the second index for representing the risk preference degree of the user.

14. The system according to claim 11, wherein the determining a user risk level of the user according to the first index and the second index comprises:
determining a risk tolerance level of the user according to the first index;
determining a risk preference degree level of the user according to the second index; and
determining the user risk level of the user according to a predetermined level correspondence table, the level correspondence table being used for describing a correspondence among the risk tolerance level, the risk preference degree level, and the user risk level.

15. The system according to claim 14, wherein the level correspondence table is determined through the following process:
determining level numbers of risk tolerance levels, risk preference degree levels, and user risk levels respectively; and
determining, based on the determined level numbers, a risk tolerance level and a risk preference degree level corresponding to each user risk level, to obtain the level correspondence table.

16. A non-transitory computer-readable storage medium for determining a risk level of a user, the storage medium configured with instructions executable by one or more processors to cause the one or more processors to perform operations comprising:
obtaining first user data and second user data of a user, the first user data reflecting at least one user attribute related to a risk tolerance of the user, and the second user data being behavior data generated during a risk-related transaction of the user;
determining, according to the first user data, a first index for representing the risk tolerance of the user;
determining, according to the second user data, a second index for representing a risk preference degree of the user; and
determining a user risk level of the user according to the first index and the second index.

17. The storage medium of claim 16, wherein the determining, according to the first user data, a first index for representing the risk tolerance of the user comprises:
for each of the at least one user attribute, determining an attribute characteristic of the user according to the first user data; and
inputting the attribute characteristic into a first machine classification model to determine an output of the first machine classification model as the first index for representing the risk tolerance of the user;

18. The storage medium according to claim 16, wherein the determining, according to the second user data, a second index for representing a risk preference degree of the user comprises:
for each of a plurality of specified variables, determining a characteristic value of the user according to the second user data, the plurality of specified variables comprising at least one specified variable that affects the risk preference degree of the user; and
for each of the plurality of specified variables, inputting the characteristic value of the user into a second machine classification model, and determining an output of the second machine classification model as the second index for representing the risk preference degree of the user.

19. The storage medium according to claim 16, wherein the determining a user risk level of the user according to the first index and the second index comprises:
determining a risk tolerance level of the user according to the first index;
determining a risk preference degree level of the user according to the second index; and
determining the user risk level of the user according to a predetermined level correspondence table, the level correspondence table being used for describing a correspondence among the risk tolerance level, the risk preference degree level, and the user risk level.

20. The storage medium according to claim 19, wherein the level correspondence table is determined through the following process:
determining level numbers of risk tolerance levels, risk preference degree levels, and user risk levels respectively; and
determining, based on the determined level numbers, a risk tolerance level and a risk preference degree level corresponding to each user risk level, to obtain the level correspondence table.
